(19) United States
(12) Patent Application Publication
(10) Pub. No.: US 2017/0169598 A1
(43) Pub. Date: Jun. 15, 2017

(54) SYSTEM AND METHOD FOR DELIVERING AUGMENTED REALITY USING SCALABLE FRAMES TO PRE-EXISTING MEDIA

(71) Applicants: Christina York, Ann Arbor, MI (US); Henry Duhaime, Grosse Pointe Farms, MI (US)

(72) Inventors: Christina York, Ann Arbor, MI (US); Henry Duhaime, Grosse Pointe Farms, MI (US)

(21) Appl. No.: 15/437,656

(22) Filed: Feb. 21, 2017

Related U.S. Application Data
(63) Continuation of application No. 14/991,755, filed on Jan. 8, 2016.
(60) Provisional application No. 62/101,967, filed on Jan. 9, 2015.

(51) Int. Cl. G06T 11/60; G06T 19/00; A63F 13/213; G06F 17/30; A63F 13/53; G06K 9/00; G06T 13/40

(52) U.S. Cl. CPC G06T 11/60; G06K 9/00671; G06T 19/006; G06T 13/40; G06F 17/30047; A63F 13/53; A63F 13/213

(57) ABSTRACT

An augmented reality system that provides multi-media presentations super-imposed on and presented in conjunction with a standard printed book. The multi-media presentation may either be superimposed on the printed book itself; or on a scalable frame, called a virtual portal. A user electronic appliance, possessing a display screen, a camera, and a software application, takes an image of a printed page. A unique visual identifier is associated with each page. A multi-media presentation, including a video component, an audio component, and, optionally, a haptic component, is associated with unique visual identifier.

### CLAIM OF PRIORITY

This U.S. utility patent application is a continuation-in-part of U.S. utility patent application Ser. No. 14/991,755, filed Jan. 8, 2016. U.S. utility patent application Ser. No. 14/991,755 was a non-provisional application of the U.S. provisional application No 62/101,967, filed Jan. 9, 2015.

### FIELD OF INVENTION

This invention relates to the class of computer graphics processing and selective visual display systems. Specifically, this invention relates to augmented reality systems that interact with pre-existing media, such as videos or printed books.

### BACKGROUND OF INVENTION

This is a continuation-in-part of U.S. Utility patent application Ser. No. 14/991,755, published at Publication No. 20160203645, which is incorporated herein, by reference. application Ser. No. 14/991,755 provides ample details of the background of this invention, including its market-need. There is a market need to extend augmented reality to pre-existing media of all sorts, for example, printed books, movie DVDs, and gaming DVDs. There is a huge, installed base of pre-existing media, such as books, movies, and games, which are currently excluded from use with augmented reality technology. The limitations of current technology can be seen in that market acceptance of the current augmented reality solutions is low. None of the current solutions have achieved mass-market appeal.

### Prior Art Review

To truly meet the market demand, augmented reality should work with pre-existing printed, audio, and video media. An augmented reality system should allow users to create and store their own content, including avatars. Such an augmented reality system will benefit both users and media producers, such as producers and publishers. There is substantial prior art in augmented reality, but seemingly almost none related directly to using augmented reality for pre-existing media.

There is prior art related to using augmented reality with specifically designed books containing pre-determined fiducial marks. For example, U.S. Pat. No. 9,286,724, by named inventors Lucas-Woodley, et al., entitled, “Augmented reality system,” teaches a system including an augmented reality device and a specialty book, intended for use with the augmented reality device, wherein the specialty book contains a fiduciary marker. There are several additional applications that have electronic books which are augmented reality enabled, including but not limited to: U.S. Patent Application Publication No. 20130201185 (Sony electronic book); U.S. Patent Application Publication No. 20140002497 (Sony electronic book); and U.S. Patent Application Publication 20140210710 (Samsung electronic book).

There is prior art related to identifying a target media for use in an augmented reality system, without the target having a specific fiducial mark. In addition to U.S. Utility patent application Ser. No. 14/991,755, published at Publication No. 20160203645, from which this application is a continuation-in-part, there is, for example, U.S. Utility Patent Application Publication No. 20150228123, by named inventor Yasutake, entitled, “Hybrid Method to Identify AR Target Images in Augmented Reality Applications,” teaches a method for detecting an augmented reality (AR) target image and retrieving AR content for the detected AR target image, based on the data of the AR target image, a plurality of markers on the AR target image; and a set of cross ratios calculated from the markers.

There is prior art related to identifying virtual objects suitable for use in augmented reality. For example, U.S. Utility Patent Application Publication No. 20160086381, by named inventors Jung, et. al, entitled, “Method for Providing Virtual Object and Electronic Device Therefor,” teaches looking in database for virtual objects which meet a present set of conditions communicated from the user's electronic device. If none of the objects meet all of the present conditions, the method finds the most-appropriate virtual object.

There is prior art related to constructing queries associating digital images, captured by a camera within an augmented reality system, with an augmented reality presentation. For example, U.S. Utility Patent Application Publication No. 20150317836, by named inventors Beaurepaire, et. al, entitled, “Method and Apparatus for Contextual Query Based on Visual Elements and User Input in Augmented Reality at a Device,” teaches a method that receives at least one input specifying content information, wherein the input is received via at least one user interface presenting image data, and the method processes the data image to construct at least one query.

There is prior art related to interacting with augmented reality or virtual reality objects. For example, U.S. Utility Patent Application Publication No. 20150177518, by named inventors Wong, et. al., entitled, “Methods and Devices for Rendering Interactions Between Virtual and Physical Objects on a Substantially Transparent Display,” teaches a method and device for having an AR virtual object, totem, or avatar interact with the wearer of the device, or with some other real-world object.

There is prior art related to using augmented reality to assist with printing documents or making presentations of documents. For example, U.S. Pat. No. 7,769,772, by named inventors Weyl, et. al, entitled, “Mixed media reality brokerage network with layout-independent recognition,” teaches a system of making a mixed media document from a print document and an electronic document, such as a picture, movie, or web link.

Some patents teach methods of using image capture to identify documents or to capture image patches. For example, U.S. Pat. No. 8,600,989, by named inventors Hull, et. al, entitled, “Method and system for image matching in a mixed media environment,” teaches a method and system for identifying a page or document using an image or text patch of a page or document.

Augmented reality has been used to help with translation. For example, U.S. Pat. No. 8,965,129, by named inventors Rogoski, et. al, entitled, “Systems and methods for determining and displaying multi-line foreign language translations in real time on mobile devices,” teaches a method and system using a video feed in real time to capture one or more text lines in a bounding box, using shape and other attributes to determine the actual text, and then translating the text, displaying the translation on top of the video feed.

Augmented reality prior art has disclosed methods for putting metadata on top of an image of a document, including navigation data and geographic data. For example, U.S. Pat. No. 8,405,871, by named inventors Smith, et. al, entitled, “Augmented reality dynamic plots techniques for producing and interacting in Augmented Reality with paper plots for which accompanying metadata is accessible,” teaches a method and system using a printed plot, metadata, and a mobile electronic device to capture a picture of a printed plot, superimpose metadata on it, and then allow the user to make further annotations. This invention is designed for use in a construction context. For examples of metadata being superimposed on navigation or geographic data see also, U.S. Pat. Nos. 8,810,599 and 8,890,896; as well as U.S. Utility Patent Application Publication Nos. 20160189405 and 20150178257.

Some of the augmented reality prior art teaches methods for recalling content from an image/record library. For example, U.S. Patent Application Publication No. 20130093759, by named inventor Bailey, entitled, “Augmented Reality Display Apparatus and Related Methods Using Database Record Data,” teaches a system and method that captures an image, sends the image to a database, identifies a record based on the image, supplies the record to the display, and superimposes the record on top of and/or with the image on a display device.

Although there is significant prior art related to augmented reality superimposed on top of a captured image, there is none that directs this technology towards pre-existing media, allowing pre-existing printed, audio, and video media to have augmented reality superimposed on top of it.

### SUMMARY OF THE INVENTION

This summary is intended to illustrate and teach the present invention, and not limit its scope or application. The present invention is an augmented reality system for use with pre-existing media, wherein the pre-existing media can be defined by a related number of occurrences. For example, with the printed book, each page would be an occurrence, and all of the occurrences within the book would be related by the relative position of each page. For pre-existing video augmented reality, depending on the available bandwidth and processing power, an occurrence could be a frame of video; a sequence of frames of video; a scene; or the entire video. For pre-existing audio augmented reality, an occurrence would be the entire song for shorter pieces. For longer pieces, such as symphonies or operas, an occurrence would be a movement or an act, respectively.

The present invention will be illustrated by discussing its application to pre-existing printed books, but the invention works with any pre-existing media. The user would view the augmented reality by viewing, for example, a page of the pre-existing printed book using a resident software application on a user electronic appliance such as a mobile phone, a tablet, augmented reality goggles, laptop computer, monitor and camera, or any other fixed or mobile electronics possessing a display, a camera, a processing unit, and a communication means. The user electronic appliance resident software application would interact with a remote source provider such as a database and server configuration. The augmented reality system would store media for each occurrence of a pre-existing medium, such as each page of a book, within a database. The augmented reality media associated with each occurrence, such as a particular page, would be transmitted to the user electronic appliance from the remote source provider using a communication means. The communication means can be accomplished by a communication chain including one or more of the following: cellular phone, wi-fi, Bluetooth, internet, Wide-area Network (“WAN”), Local-area Network (“LAN”), Personal-area Network (“PAN”), gaming console, and/or entertainment system.

Each occurrence, such as a page of a book or a scene in a movie, is saved as a unique identifier. An image is taken of the occurrence. A number of features, such as pictures, graphics, text, page numbers, text, text patterns, relative location of pairs of letters, color gradients, color saturation, identifiable objects, and location of particular letters related to the occurrence are identified from the image. A unique identifier for each occurrence is created from one or more of the features. The unique identifier can either be created in the software application resident on the user electronic appliance, or on the software application resident on the remote server.

Media covers can facilitate in quick-loading the data related to expected occurrences. For example, the cover of a movie DVD can speed loading all of the occurrences related to the DVD. The spine, cover, and ISDN of a book can be associated with a particular title and the associated set of unique occurrence identifiers related to each page. For example, when the user device sees a DVD cover or a book spine, the appropriate augment reality for all occurrences associated with that particular DVD cover or spine are requested from the server and loaded. The media covers can also be used to help a user find videos, games, or books that have available augmented reality. For example, a user can use a cellphone or other mobile device with image capture capability to identify videos, games, or printed books for which the augmented reality within the application exists. The user electronic appliance will then superimpose augmented reality, such as highlighting, over the cover of the video DVD, game DVD, or printed book's title or spine. Other methods of associating pre-existing media with the associated augmented reality database can be used, such as RFID, magnetic ink, magnetic strips, ultraviolet or infrared ink. For example, with DVDs or books containing RFID chips, the application can read the RFID chip and identify if the pre-existing media is associated with a record augmented reality database.

The user electronic appliance is triggered to capture the image of the occurrence. The triggering can be performed manually by the user. The triggering can also be automatic, based on a clock counter capturing an image on a pre-defined interval. The triggering can also be automatically continuous, occurring repeatedly, as quickly as the user electronic appliance allows. The triggering of the image capture can also be predicated on a signal from a motion sensor, such as a gyroscopic chip or other haptic enabled electronics. The triggering would occur when the motion sensor met some pre-defined criteria, allowing for triggering when the user electronic appliance is shaken, for example.

The augmented reality can be viewed on a user electronic appliance, such as a cellphone, tablet, computer, augmented reality goggle, or any other portable or fixed user electronics that has the appropriate display, image capture, processing, memory, and communication capabilities. The user electronic appliance needs to provide sufficient hardware resources for the resident end-user application.

Each occurrence, such as the scene of a movie, a level or a scene in a video game, or a page in a printed book, is associated with a record. The record contains, at a minimum, an image associated with the occurrence, the unique identifier, and a multi-media presentation. A stored augmented reality multi-media presentation can include, but is not limited to, video, animation, stop motion animation, pictures, graphics, sounds, images, and vibrations. The stored augmented reality multi-media presentation can be supplemented with images, characters, graphics, sound effects, and other media created by a user and stored in that user's library. The user can, also, make an avatar that can interact with the pre-existing media and the augmented reality associated with each occurrence of the pre-existing media. The avatar can interact with the stored augmented reality multi-media presentation through a variety of interfaces, such as a touch screen, keyboard, device movement, mouse, and user motion (e.g., waving hands or feet). The avatar, and the multi-media presentation, itself, can be triggered by sound, movement of the user, movement of the user electronic appliance, or other video, audio, or haptic means. The stored augmented reality multi-media presentation may also interact with the avatar without user interaction, allowing the reader to be pulled into the augmented reality portion of the story. The augmented reality system can store prior user animations, avatars, and interactions, so that each use of a particular pre-existing media can proceed from where the prior use ended. The user can also decide to start, anew, at any time.

The augmented reality, consisting of a multi-media presentation designed for the occurrence corresponding to the unique occurrence identifier, can be projected on the occurrence of pre-existing media, itself, or on a scalable frame. With scalable frames, the user would have two frame markers that could be attached to a flat surface such as a wall or floor. The user electronic appliance can calibrate the placement of the scalable frame markers, so that the frame has the correct aspect ratio. The augmented reality can then be projected onto the printed text or onto the flat surface defined by the scalable frame markers. The augmented reality projection of the scalable frame, called a virtual portal, can be stylized to match the content of the augmented reality presentation, or it can be defined by the user. A user can interact, using a touch-screen enabled electronic appliance, with the digital assets of the augmented reality presentation that are within the portal. If the electronic appliance is connected with a system that has a projector, the projector can project an image of the augmented reality presentation to the portal.

The multi-media presentation would be triggered in order to start play. The multi-media presentation could be triggered manually, or upon certain conditions being met. For example, the multi-media presentation could be triggered by aiming the image capture device at the scalable frame. Once the software application on the user electronic appliance registers the scalable frame, the multi-media presentation starts. Similarly, the multi-media presentation could be triggered by aiming the image capture device at the occurrence with the unique occurrence identifier. The multi-media presentation can be made to start if a certain amount of time has elapsed. Additionally, playback can be enabled with haptics.

The stored augmented reality and supplemental library and avatar can be rendered using either proprietary, purchased, or open source rendering solutions. Rendering the augmented reality associated with each occurrence is performed by associating the unique occurrence identifier with a stored multi-media presentation on the server. Upon the application, resident on the user electronic appliance, requesting a particular pre-existing media, portions of the record, including the multi-media presentation, can be transmitted, via the communication means, for quick loading. In order to speed loading of rendered multi-media, the application software can also use video layering, allowing each layer to launch independently. The multi-media logic can track whether certain layers have rendered, and are thus available for interaction by the user, or use by the stored multi-media presentation. The rendering system can be created so that augmented reality starts before the entire occurrence or book is downloaded, thus speeding the user's interaction.

To speed loading, the application can also identify such information as where the user started a prior session, where the user ended a prior session, and what is the most viewed occurrence. The information can then be used to prioritize the loading of certain occurrences. In this way, the system can be ready for use while it is still downloading information from the remote server.

A library of digital assets related to augmented reality is very large. As a result, the information may be transmitted using either lossy or lossless data compression techniques. With lossy compression techniques, the loss in fidelity will be acceptable for certain device sizes, such as cellphones. The tradeoff in such a case between a lossy compression technique and the speed of transmission and loading will be acceptable. When higher media fidelity is desired, loseless compression can be used.

During a session, all user created animation and media can be stored, so that when the user goes back to a previous occurrence, all of the graphics are there. Logic can be embedded within the augmented reality that allows it to extrapolate position and interaction of user created media on each new occurrence. This will allow user-created augmented-reality to be placed on a new occurrence, ready for use upon the occurrence being advanced, such as a page flip or the video changing scenes. At the end of a session, all of the user's interactions and all of the user-created media can be stored as input to the next user session with a particular title. With such a system, it will not matter if a user proceeds non-linearly through a session, as each occurrence is stored independently, and the user-created media is interpolated and/or extrapolated onto each new occurrence.

The augmented reality can be implemented with use-context logic, so that certain media is provided, excluded or modified based on the use context detected. Use context can include random page flipping, scene scanning, shaking or moving the electronic device, user inaction, user hyper-action, etc.

The augmented reality system and method can gather use data for associated with a particular piece of pre-existing media. For example, the system and method will collect information about what books kids read, which ones they read repetitively, which books they read “together” (in a single reading session), what parts of books they engage with most (at the page level and even at the interaction level), how frequently they read specific titles, etc. Additionally, the augmented reality system will collect information about what videos a user plays repeatedly, what levels or scenes they interact with repetitively, and associated video games (i.e., video games that a user tends to play sequentially). The system will generate and analyze non-self-reported use habits. The aggregated data is assembled by usage independent variables, that includes, but is not limited to, media type, theme, sex of user, age-group, complexity level (i.e., rating of a movie, level of a book, or difficulty of a video game), user electronic appliance type, geography, time of day, and length of session. For specific types of media, content-specific data can be collected. For example, with pre-existing printed media, data concerning the type of book can be collecting, including, but not limited to, total word-count, word-count per page, word size, font size, font type, and illustration density. Dependent variables can include, but are not limited to, frequency of a particular pre-existing media being used, occurrence interaction, pre-existing media cross-correlation, duration of time spent on a particular pre-existing media, duration of time spent on each page of occurrence, and motion (whether image is stable or moved around). Data analytics can then be used to help publishers and producers identify popular themes.

### BRIEF DESCRIPTION OF THE DRAWINGS

FIG. 1 is a flow chart of a top-level software process. FIG. 2 is a high level flowchart of a user validation sub-process. FIG. 3 is a high level flowchart of a title identification sub-process. FIG. 4 is a high level flowchart of an occurrence loading sub-process. FIG. 5 is a high level flowchart of a runtime sub-process.

FIG. 6 is a system communication diagram.

FIG. 7A is a display showing available pre-existing media on a user's electronic appliance. FIG. 7B is a display showing a user's library.

FIG. 8 is a diagram of a user using the invention.

FIG. 9 is a diagram showing the presentation layers of the invention.

FIG. 10 is a system block diagram.

FIG. 11 is a diagram showing the presentation layers of the invention when using scalable frames.

FIG. 12 is a high level flowchart of the frame sub-process.

FIG. 13 is a front view of the scalable frame calibration on a cellphone.

FIG. 14 is a front view of the scalable frame markers, calibration, and portal.

FIG. 15 is a front view of a variety of portals.

### DETAILED DESCRIPTION OF THE DRAWINGS

The following descriptions are not meant to limit the invention, but rather to add to the summary of invention, and illustrate the system and method for displaying augmented reality for pre-existing media. The system and method presented with the drawings is one potential system and method for implementing augmented reality with pre-existing media, with multiple embodiments on how to project the augmented reality.

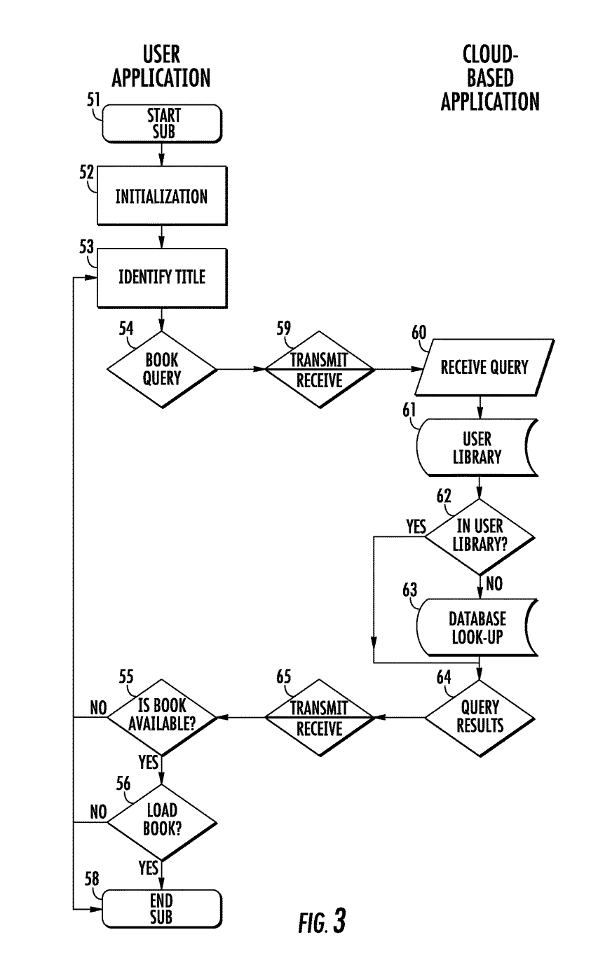

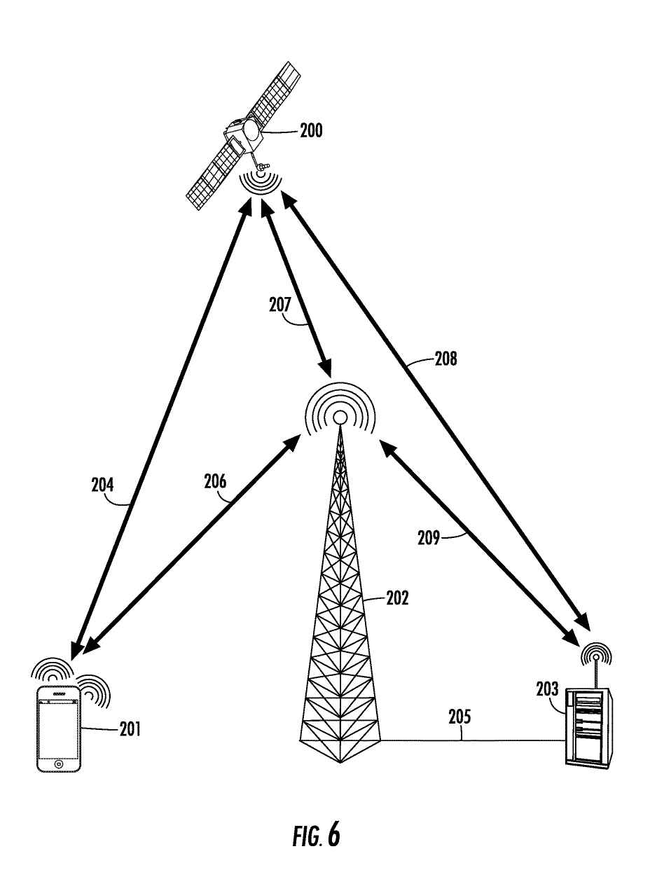

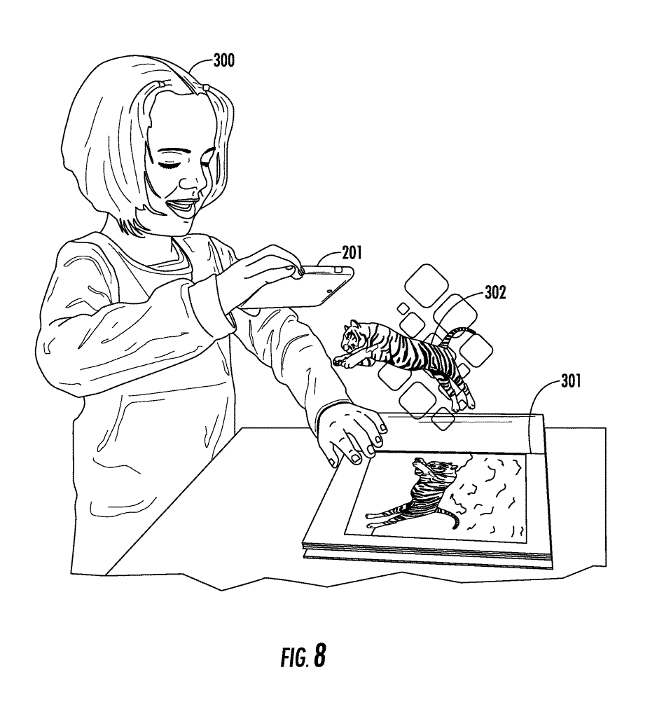

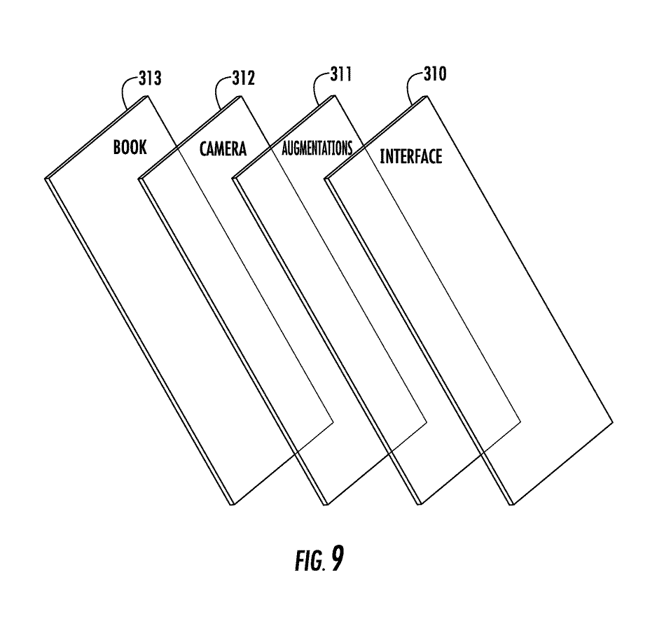

FIG. 10 shows a high-level block system diagram of the software method architecture 400 used by the present invention. The framework 405 of the system is referred to as Spellbound™ 405. Spellbound™ 405 is connected to a routine to scan 401, a user library 417, a user account 402, and a store 412. The scan 401 routine allows the user to focus a user electronic appliance 201 (see FIGS. 6 and 8) over an occurrence, such as the page of a printed book 301 (see FIG. 8). The Spellbound™ 405 application then uses a unique visual identifier to identify library content 417, or titles 413 available from the store 412, which correspond to the unique visual identifier.

The user library 417 has pre-existing media titles 422. Each pre-existing media title 422 has associated occurrences 423, options 421, games/quizzes 420, and active profile 418. The occurrences 423 include user content 424. The user account 402 has a profile 411, an e-mail address 404, and payment information 403. The profile 411 includes spending limits 410, settings 409, rewards 408, quiz/game state 407, bookmarks 406, and customizations 405. The store 412 has titles 413 for purchase. Each title 413 has an associated print book 414, movie 498, or video game 499, and a spellbook 415. Each spellbook 415 has enchantments 416, which are the augmented reality 416 associated with each occurrence 423.

As an example of the implementation of the present invention, FIG. 8 shows a user 300 reading a print book 301 with the spellbook 415 enchantments 416 presented as a three-dimensional animation 302 jumping off of the page of the printed book 301. The user 300 holds the user electronic appliance 201 through which the user 300 can see the enchantments 416, 302 of the spellbook 415 super-imposed on the printed book 301. The user 300 can trigger new enchantments 416 through her 300 actions, including the action of turning the page 301. Other triggers that would result in new media or enchantments 416 being loaded include the user 300 reading portions of the book 301 out loud, clapping, whistling, blowing, moving the book, and moving the user electronic appliance 201. User 300 context can also act as a trigger. For example, inaction, switching the user electronic appliance 201 between two pre-existing media, repetitive occurrence changes such as flipping back and forth between the same two pages or scenes, and random occurrence changes, such as flipping pages non-sequentially or advancing scenes in a movie non-sequentially, can also be used as triggers.

The enchantments 416, 302 can include a video component, an audio component, and a haptic component. The video component can be displayed on the user electronic appliance 201 display screen. The video component can be flat, static graphics in plane with the pre-existing; flat animation in plane with the pre-existing media; flat, static graphics raised above the pre-existing media; flat animation raised above the pre-existing media; three-dimensional, static graphics coming out of the pre-existing media; three-dimensional animation coming out of the pre-existing media; three-dimensional, static graphics projecting into the pre-existing media; and three-dimensional animation projecting into the pre-existing media. For example, when used with a book, the video component can be a flat, static graphics in plane with the page; flat animation in plane with the page; flat, static graphics raised above the page; flat animation raised above the page; three-dimensional, static graphics coming out of the page; three-dimensional animation coming out of the page; three-dimensional, static graphics projecting into the page; and three-dimensional animation projecting into the page.

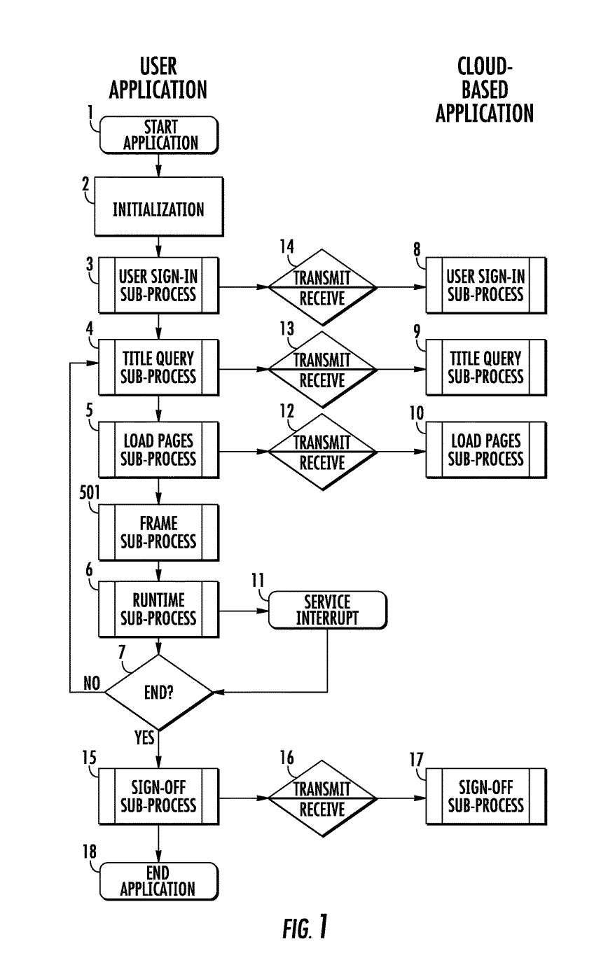

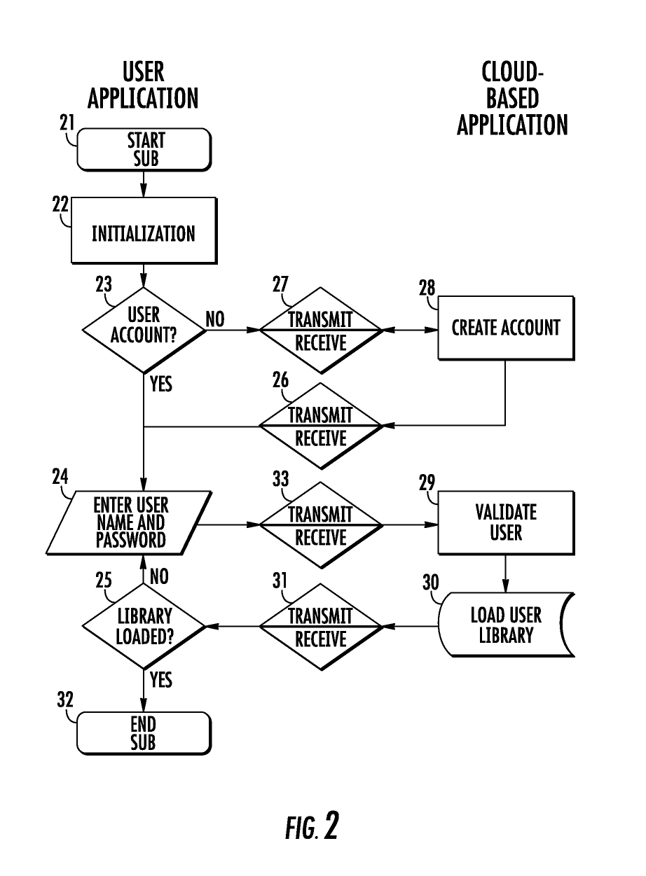

FIGS. 1-5 define parallel User Application software processes and Cloud-Based Application processes for use in an augmented reality system for pre-existing media. The embodiment presented, herein, is illustrative, only. Modules, routines, functions, and processes can be implemented as either a User Application, Cloud-Based Application, or a combination of both.

The User Application and Cloud-Based Application need to perform, at a minimum, four parallel sub-processes: sign-in, title query, occurrence loading, and sign-off. In addition, the User Application needs to perform, at a minimum an additional runtime sub-process. These sub-processes are managed and launched by a top-level process. FIG. 1 shows the top-level, high-level flowchart for a system for delivering augmented reality to pre-existing media. The user (see, e.g., FIG. 8, 300) starts 1 the user application on the user electronic appliance (see e.g., FIG. 8, 201). The User Application initializes 2, and then launches a Sign-In Sub-Process 3.

The User Application Sign-In Sub-Process 3 transmits and receives 14 information to/from a Cloud-Based Application Sign-In Sub-Process 8, which validates the user 300. The Sign-In Sub-Process 3, 14, 8 is presented in more detail in FIG. 2. After validation or approval is received from the Sign-In Sub-Process 3, 14, 8, the User Application launches a Title Query Sub-Process 4. The User Application Title Query Sub-Process 4 transmits and receives 13 information to/from a Cloud-Based Application Title Query Sub-Process 9. The Title Query Sub-Process 4, 13, 9 is presented in more detail in FIG. 3. After the Title Query 4, 13, 9 confirms that a title is available for augmented reality, the User Application launches a Load Occurrences Sub-Process 5. The User Application Load Occurrences Sub-Process 5 transmits and receives 12 information to/from a Cloud-Based Application Load Occurrences Sub-Process 10. The user 300 has to use a user electronic appliance 201 to capture an image of an occurrence of a pre-existing media. The image of pre-existing media is associated with a unique visual identifier for that occurrence. The information received from the Cloud-Based Application Load Occurrences Sub-Process 10 is the record, or spellbook 415 associated with the title; the record, or spellbook 415, is comprised of a series of augmented reality presentations for each occurrence, which are called enchantments 416. The record 415 contains a multi-media presentation 416 associated with an occurrence, which, in turn, is associated with the unique occurrence visual identifier. The Load Occurrences Sub-Process 5, 12, 10, is presented in more detail in FIG. 4.

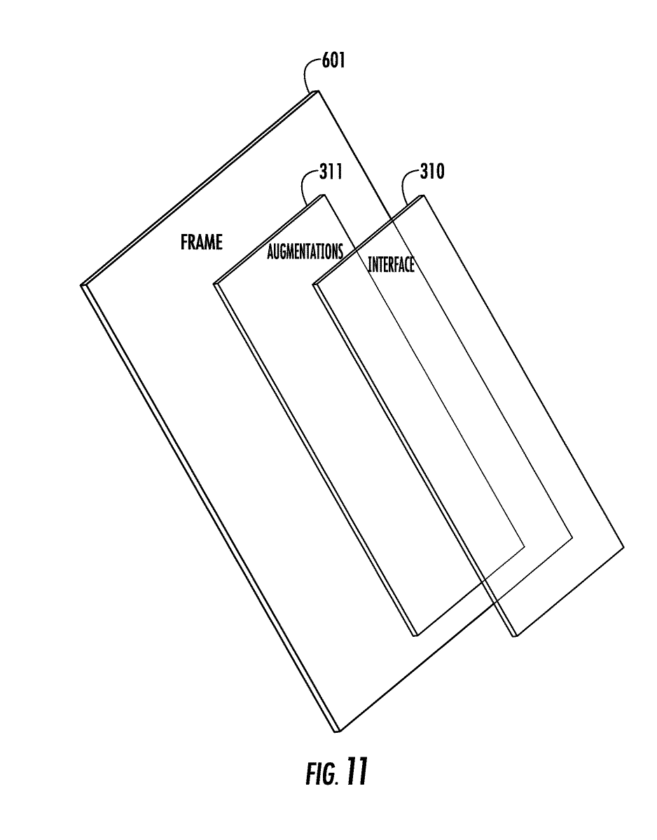

After the Load Occurrences Sub-Process 5, 12, 10 loads augmented reality information 415, 416 associated with one or more occurrences, the User Application launches a Frame Sub-Process 501. In a first alternative embodiment, the User Application can simultaneously launch both the Frame Sub-Process 501 and the Runtime Sub-Process 6. In a second alternative embodiment, the User Application can simultaneously launch the Load Occurrences Sub-Process 5, 12, 10, and the Frame Sub-Process 501. In a third alternative embodiment, the Frame Sub-Process 501 is a sub-process of the Runtime Sub-Process 6. The Frame Sub-Process 501 is presented in more detail in FIG. 12.

Next, the User Application launches the Runtime Sub-Process 6. The User Application can proceed independently of the Cloud-Based Application while executing the Runtime Sub-Process 6. The User Application Runtime Sub-Process 6 presents the user 300 with augmented reality associated with one or more occurrences of pre-existing media, using the record stored 415 in a database, which is associated with a unique visual identifier corresponding to the occurrence of the pre-existing media. The augmented reality multi-media presentation 416 can be graphics, animation, sound, haptics, or other multimedia presented to the user electronic appliance 201. The Runtime Sub-Process 6 is enabled with a Service Interrupt 11, which allows the User 300 to stop the augmented reality multimedia presentation 416. The Service Interrupt 11 can be implemented with a soft-key, hard-key, touch-screen, voice command, or haptic control. The Runtime Sub-Process 6 is presented in more detail in FIG. 5.

Either when the Service Interrupt 11 is activated or the Runtime Sub-Process 6 terminates, the User 300 is presented with a choice to either end the session or continue with a new title 4 of pre-existing media through the use of a User Termination Control 7. The User Termination Control 7 can be implemented with a soft-key, hard-key, touch-screen, voice command, or haptic control.

When the User 300 terminates a session, either through action or inaction, the User Application launches a Sign-Off Sub-Process 15. The User Application Sign-Off Sub-Process 15 transmits and receives 16 to/from a Cloud-Based Application Sign-Off Sub-Process. The Sign-Off Sub-Process 15, 16, 17 ends the User's 300 session and stores any user-created content or new printed books that the user 300 purchased into the User's library 417. This ends 8 the main process.

FIG. 2 is a high-level flowchart of the Sign-In Sub-Process 3, 14, 8 discussed pursuant to FIG. 1. The sub-process starts 21 and is initialized 22, passing any necessary variables. The user 300 (or the user's 300 parent, if the user 300 is a child) is given a choice to create a new account 23 or enter the user's 300 name and password 24. The information is transmitted 26, 27, 33 to the Cloud-Based Application, where it serves as the input to the appropriate function, either Create Account 28 or Validate User 29. If the User 300 creates a new account 23, 27, 28, the Cloud-Based Application transmits 26 a prompt to the User Application to ask the User 300 to enter their name and password 24, after creating a new account 28. If the User 300 provides the correct user name and password 24, which is transmitted 33 to the Cloud-Based Application, the Validate User 29 function will Load User Library 30. Load User Library 30 then transmits 31 the User's library to the User Application. The User Application knows to end the sub-process when the library is loaded 25, 32.

FIG. 3 is a high-level flowchart of the Title Query Sub-Process 4, 13, 9 discussed in FIG. 1. The sub-process starts 51 and is initialized 52, passing any necessary variables or information. The user 300 gives the User Application input to Identify Title 53, including, but not limited to, the following: typing in a title; using an image of the DVD cover, title, or spine of a book, DVD movie, or video game; sensing an RFID or other near-field chip; sensing magnetic ink or strip; or sensing infra-red or ultra-violet ink. The User Application identifies the Pre-existing Media Query 54 and transmits and receives 59 information from the Cloud-Based Application, which Receives Query 65. The Cloud-Based Application determines if the Title 422 is in the User Library 61, 62. If the Title 422 is available in the User Library 61, this result is loaded as the Query Results 64. If the title is not present in the User Library 61, the sub-process performs a Database Look-up 63 to determine if the Title 413 is available for augmented reality treatment, and loads this as the Query Results 64. The Query Results 64 is transmitted 65 to the User Application, which uses the Query Results 64 to determine if the Pre-Existing Meida is Available 55. If the Pre-Existing Media is Available 55, the User 300 is asked if they want to Load the Pre-existing Media 56. If the User 300 wants to Load Pre-existing Media 56, the result is passed as the value from the sub-process, and the sub-process ends 58. If the User 300 does not want to load the Pre-existing Media 56, or if the Pre-existing Media is not available 55, the User 300 can search another title 53 or end the process 58.

FIG. 4 shows the Load Occurrence Sub-Process 5, 12, 10. The sub-process starts 71 and initializes 72 with positive query results 56 from the Title Query Sub-Process 4, 13, 9. The User 300 prompts the User Application to proceed by capturing an image 73 of an occurrence (e.g., 301) using the user electronic appliance 201. This is transmitted 74 to the Cloud-Based Application, which searches the database for a Occurrence ID 75. The augmented reality is supplemented with information from the User Library 76. The Cloud-Based Application will Determine Occurrence Transmission Order 77 based off of the occurrence from the Image Capture 73 and from the User Library 76. The information 415, 416 will be compressed 78 and transmitted 79 to the user electronic appliance 201, where it will be decompressed 80 by the user application. The augmented reality 416 corresponding to the occurrence will be loaded 81 in a process with a Service Interrupt 82. If the Service Interrupt 82 stops the Load Occurrence 81 routine, the user Application will allow the user 300 to end the sub-process 83 ,84, or go back to Image Capture 73. If Load Occurrences 81 successfully loads the occurrence(s) 416, the Sub-Process will end successfully 83, 84.

FIG. 5 shows the Runtime Sub-Process 6, which has Service Interrupts 11, 108, 114. In FIG. 5, the Runtime Sub-Process 6 starts 101 and is initialized 102. The Image Capture 103 has augmented reality 416 super-imposed on it by the User Application. This is done by Rendering Graphics, Cue Audio and Haptics 115. The User Application Syncs Animation, Sound and Haptics 116, and then Runs Media 117, 416. The User Application can begin Runs Media 117, prior to all layers of graphics being rendered. So although Rendering Graphics, Cue Audio and Haptics 115, Syncs Animation, Sound and Haptics 116, and Runs Media 117 are shown as sequential processes, they can be launched and executed as a partial parallel process. While the augmented reality multi-media presentation 415, 416 on the user electronic appliance Renders 115, Syncs 116, and Runs 117, the user application transmits 104 the Image Capture 103 to the Cloud-Based Application. The Occurrence ID 105 is confirmed 107, 106, prior to Rendering Graphics 115. If the Image Capture 103 does not match the Occurrence ID 105, 107 the Cloud-Based Application determines if the difference is from User Input 109. If it is, the User Input 109 is Compressed 113 and transmits 110. The user application then Decompresses/Loads 118 and Re-renders/Sync/Launch 119. At the end of the runtime, the User Application prompts the User 300 to Advance Occurrence 120 which the User 300 would either do manually by, for example, flipping the page 301, or it is done automatically by, for example, a movie advancing to the next scene in due course. If the User 120 decides to end, the Sub-Process Ends 121.

During the Runtime Sub-Process, if the Occurrence ID 107 is not confirmed, and the difference is not User Input 109, the Cloud-Based Application sends a Service Interrupt 108 to the user application, and the user application re-enters the Load Occurrence Sub-Process 108, 5, 12, 10 or is given a choice to continue in the Runtime Sub-Process 108, 114, 120.

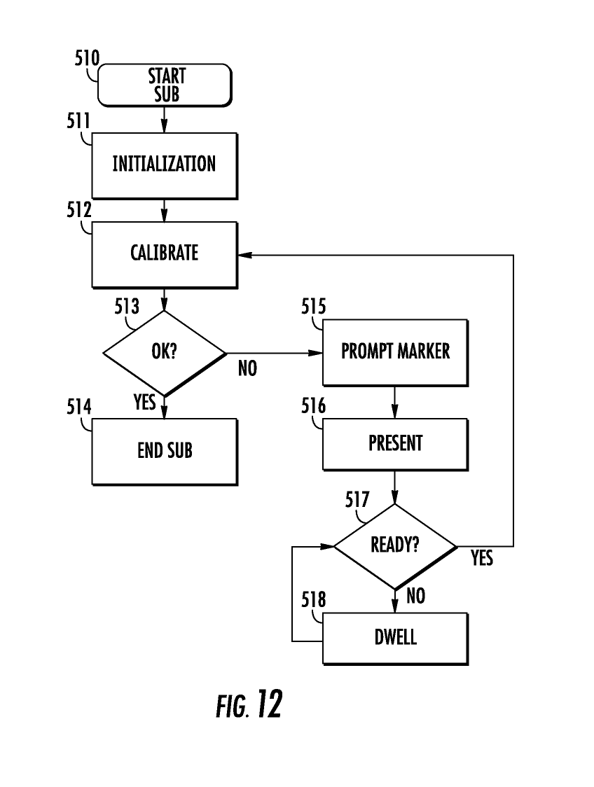

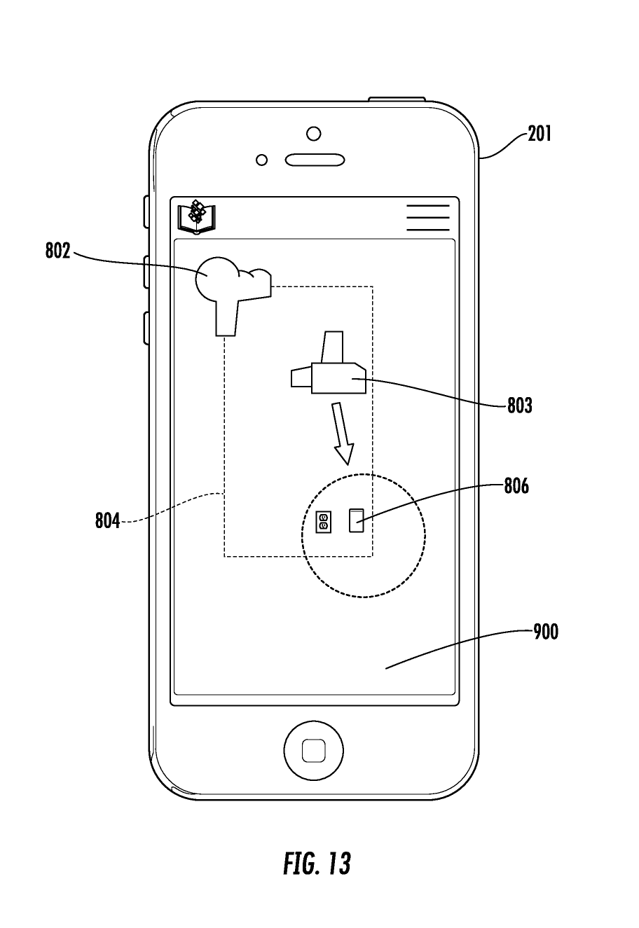

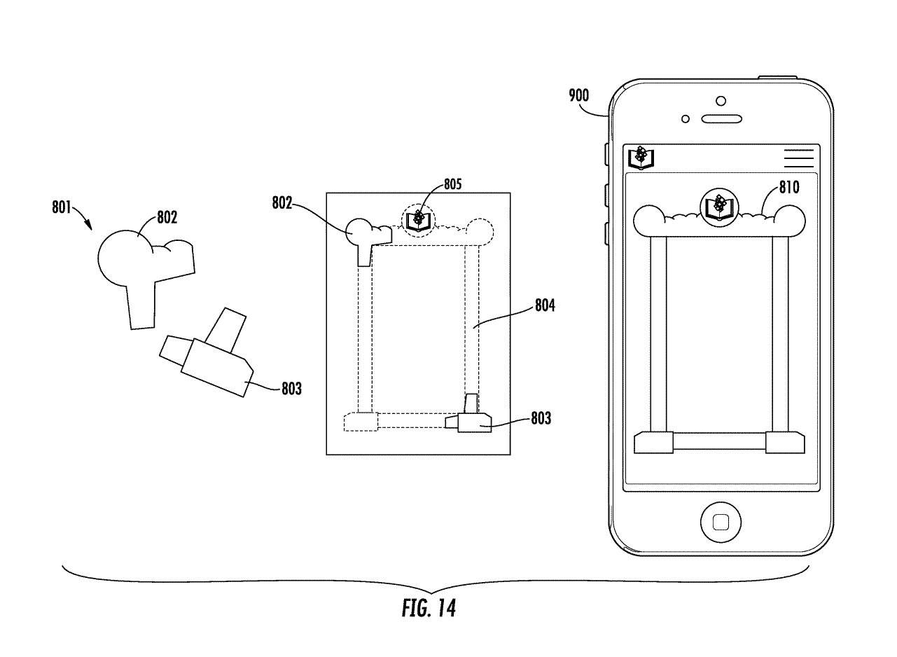

FIGS. 12-15 show the scalable frames concept, which allows the user 300 to project the augmented reality 416 onto a flat surface. FIGS. 13 and 14 show the concept of the scalable frame, including the tangible pieces of the scalable frame 801. The scalable frame has two markers 802, 803. One marker 802 is designated the upper marker 802. The other marker 803 is designated the lower marker 803. The user 300 places the two markers 802, 803 on a flat surface 921 such as a wall or floor. By aiming a user electronic appliance 201 at the upper marker 802, the user application will highlight where to place 806 the lower marker 803 on the screen 900 of the user electronic appliance 201. The user application also highlights the virtual frame 804 on the screen 900 of the user electronic appliance 201, once both the upper marker 802 and lower marker 803 are properly placed. Once the lower marker 803 is correctly placed, the user application will calibrate 512 the scalable frame 801. When the scalable frame 801 is calibrated 512, the screen 900 will show a spellbound totem 805 and convert the virtual frame 804 into an augmented reality portal 810.

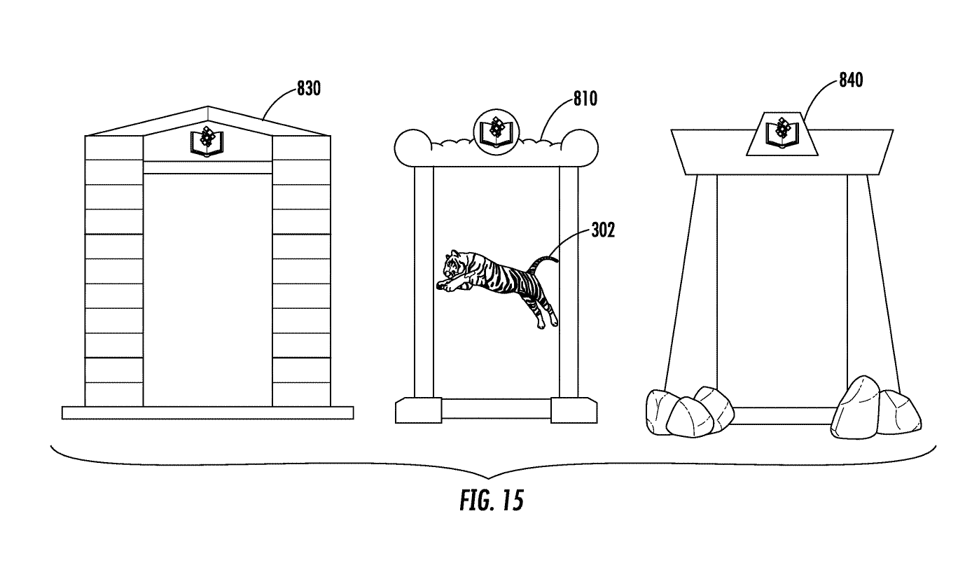

FIG. 15 shows a plurality of augmented reality portals 810, 830, 840. The augmented reality portals 810, 830, 840 act as a virtual visible gateway through which augmented reality content, called enchantments 302, 416 can be viewed.

FIG. 12 shows the Frame Sub-Process. The Frame Sub-Process 501 starts 510 and is initialized 511. During initialization 511, the user 300 is given the option of using the scalable frame 801 and the type of augmented reality portal 810, 830, 840. The Frame Sub-Process 501 calibrates 512 to insure the correct aspect ratio for the augmented reality portal 810, 830, 840, by helping the user 300 correctly place the markers 802, 803. The Frame Sub-Process 501 does this by prompting the user 300 to place the lower marker 803 in the correct place 806. The Frame Sub-Process 501 also provides a virtual frame 804 on the user's 300 screen 900, in order to facilitate the placement of the lower marker 803. The Frame Sub-Process determines 513 if the lower marker 803 is in the correct place 806. If the lower marker 803 is not in the correct place 806, the Frame Sub-Process 501 prompts 515 the user 300 to move the lower marker 803 to the correct place 806. When the user 300 moves the lower marker 803 the Frame Sub-Process 501 determines if the lower marker 803 is present 516. If the lower marker 803 is present 516, the Frame Sub-Process 501 is ready 517 and it calibrates 512. If the lower marker is not present 516, the Frame Sub-Process 501 is not ready 517 and the Frame Sub-Process 501 dwells 518.

FIG. 6 shows multiple communication paths between the user electronic appliance 201, containing the User Application, and the server 203 containing the Cloud-Based Application from FIGS. 1-5. The user electronic appliance 201 can communicate 204 with a satellite 200, which in turn communicates 207 with a cell network tower 202 which can then wirelessly communicate 209 with the server 203, or can communicate 205 through the internet or other tangible connection to the server 203. The satellite 200 can also communicate directly with the server 203, if so enabled. This is meant to be illustrative in the communication methods that could connect the user electronic appliance 201, containing the User Application, to the server 203, containing the Cloud-Based Application, and is not meant to suggest that this is an exhaustive set of the communication links between the user electronic appliance 201 and the server 203.

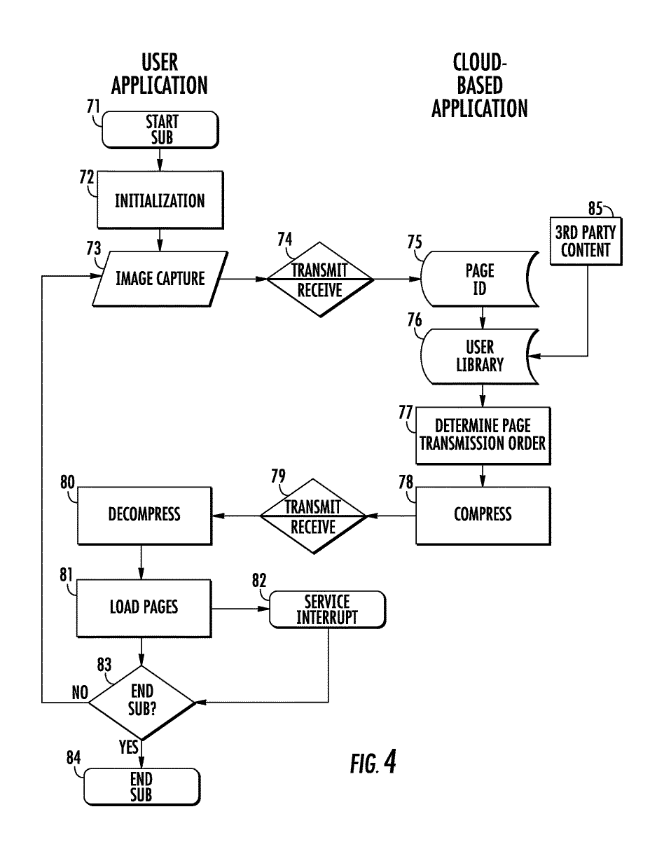

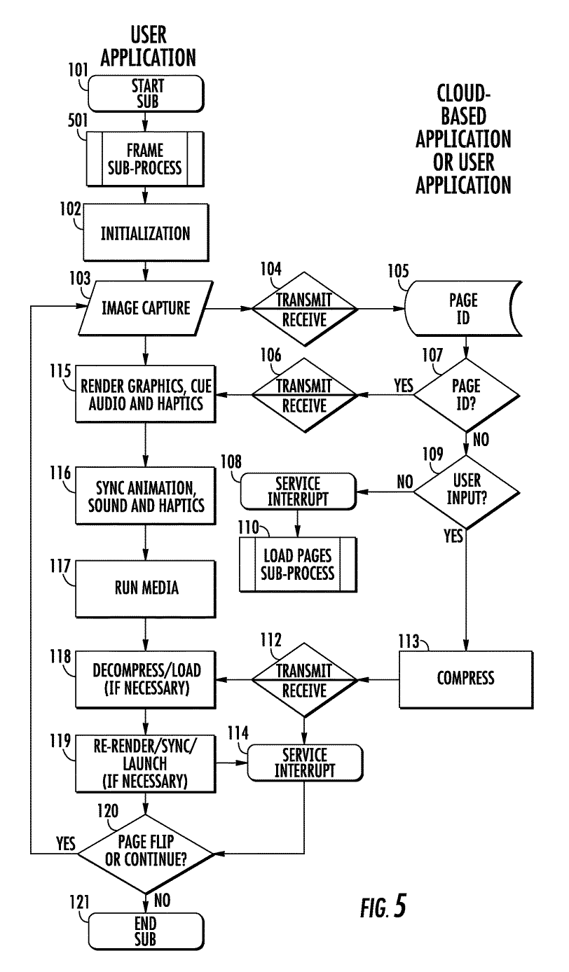

FIG. 7A shows a display of a store 412 in which a user would find 270 a new book 271, movie 279, or game The virtual store 412 would have arrows 272 that can offer expanded content 274 such as reviews 273 or descriptions of the books 271, movie 279, or game 284.

FIG. 7B shows a user library 417, represented graphically 281. The graphical user library 281 shows the plurality of books 282, movies 283, and games 284 that the user has purchased, arranged by pre-existing media type. The books 282, movies 283, and video games 284 allow the user to experience multi-media presentations super-imposed on top of pre-existing media 414, 498, 499, 301. The entier multi-media presentation, associated with a particular pre-existing media pre-existing media 414, 498, 499, 301, is referred to as the record or spellbook 415. Each spellbook 415 has particular triggerable augmented reality content, associated with particular occurrences, called enchantments 416.

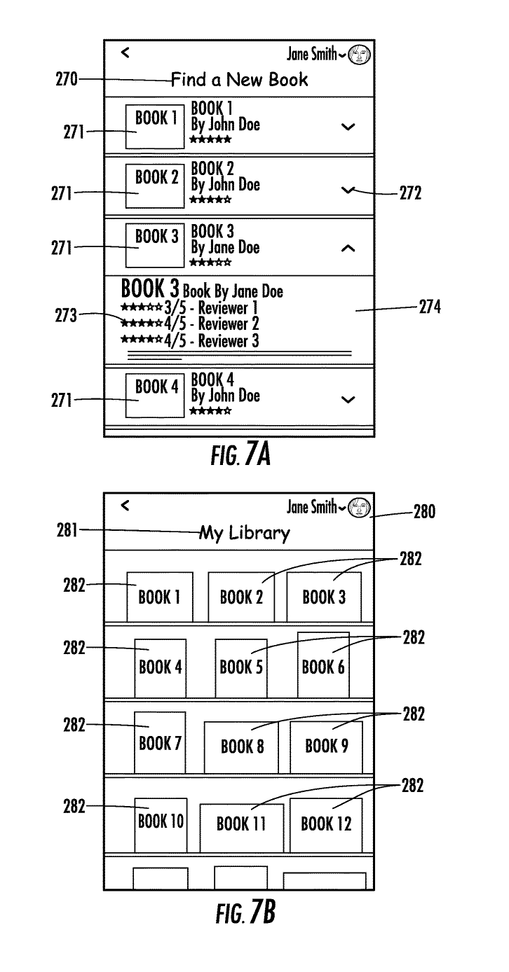

FIG. 9 shows the layers that can be presented. The invention contains at least graphic layers for the pre-existing 313, camera 312, augmentations or enchantments 311, 416, and interface 310. The pre-existing 313, camera 312, augmentations or enchantments 311, 416, and interface 310 can be super-imposed, one on top of the other. When a new occurrence loads, each of the graphic layers can be displayed as soon as it renders, meaning that the layers can be added during runtime, as each new layer is successively rendered.

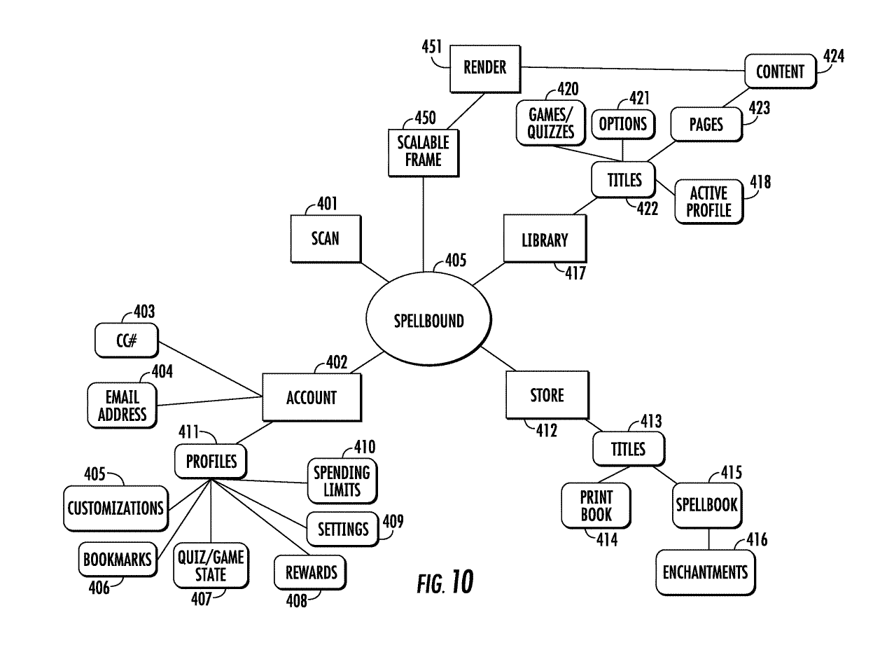

FIG. 11 shows the layers that will be placed in the scalable frame. The frame layer 601 would be larger than the augmentations layer 311 and the interface layer 310. This would keep any of the augmentation layer 311 or interface layer 310 graphics from bleeding over onto the virtual portal 810, 830, 840. At a minimum, the augmentations layer 311 and the interface layer 310 would be rendered on the frame layer 601. Optionally, the pre-existing media layer 313 and the camera layer 312 could also be rendered on the frame layer 601.

The multi-media presentation 311, 416 would be triggered in order to start play. The multi-media presentation could be triggered manually, or upon certain conditions being met. For example, the multi-media presentation 311, 416 could be triggered by aiming the image capture device at the scalable frame 801. Once the software application on the user electronic appliance registers the scalable frame 801, the multi-media presentation starts as long as the virtual frame 804 has already been calibrated 512. Similarly, the multi-media presentation could be triggered by aiming the image capture device at the pre-existing media with the unique occurrence identifier. The multi-media presentation can be made to start if a certain amount of time has elapsed. Additionally, playback can be enabled with haptics.

We claim:

1. A system to provide multi-media augmented reality for pre-existing media comprising
a user electronic appliance, comprised of a display, an image capture device, a processor, a memory element that is a first non-transitory computer readable medium, and a transmission means;
a server processing device connected to the user electronic appliance via the transmission means;
a database connected to the server processing device via circuitry;
a software application resident on the non-transitory computer readable medium of the user electronic appliance that, when running, activates the image capture device, displays the image received from the image capture device on the display of the user electronic appliance, captures an image, and transmits the captured image via the transmission means to the server processing device;
a software method, embodied on a second non-transitory computer readable medium and accessible to the server processing device, capable of identifying if the captured image received from the user electronic appliance corresponds to an occurrence from a pre-existing media by determining if the captured image corresponds to a unique visual identifier associated with an occurrence from a pre-existing media, associating the unique visual identifier with a unique augmented reality record stored in the database, wherein the augmented reality record contains a multi-media presentation, and transmitting the multi-media presentation, via the transmission means, to the user electronic appliance;
and a scalable frame, wherein the scalable frame is defined by at least two physical markers placed on a flat surface, allowing the software application resident on the user electronic device to define a bounded two-dimensional geometric shape, with a defined perimeter and interior area, called a virtual portal;
wherein the multi-media presentation contains at least a graphic component; and
wherein, when the image capture device of the user electronic appliance is aimed at the virtual portal, the graphic component of the augmented reality multi-media presentation is displayed on the display of the user electronic device, superimposed on the interior area of the virtual portal.

2. The system to provide multi-media augmented reality for pre-existing media in claim 1, wherein the pre-existing media is composed of a series of related occurrences, and the augmented reality record is composed of a series of multi-media presentations, each said multi-media presentation corresponding to a unique occurrence.

3. The system to provide multi-media augmented reality for pre-existing media in claim 2, wherein the pre-existing media is a printed book and the occurrences are the pages of the book.

4. The system to provide multi-media augmented reality for pre-existing media in claim 2, wherein the pre-existing media is a movie.

5. The system to provide multi-media augmented reality for pre-existing media in claim 4, wherein the occurrences are scenes from the movie.

6. The system to provide multi-media augmented reality for pre-existing media in claim 4, wherein the occurrences correspond to particular run-times within the movie.

7. The system to provide multi-media augmented reality for pre-existing media in claim 2, wherein the pre-existing media is a video game.

8. The system to provide multi-media augmented reality for pre-existing media in claim 7, wherein the occurrences are levels from the video game.

9. The system to provide multi-media augmented reality for pre-existing media in claim 7, wherein the occurrences are scenes within the video game.

10. The system to provide multi-media augmented reality for pre-existing media in claim 1, wherein the virtual portal is a parallelogram.

11. The system to provide multi-media augmented reality for pre-existing media in claim 1, wherein the virtual portal is a rectangle.

12. The system to provide multi-media augmented reality for pre-existing media in claim 1, wherein the virtual portal is a square.

13. The system to provide multi-media augmented reality for pre-existing media in claim 1, wherein the virtual portal is an ellipse.

14. The system to provide multi-media augmented reality for pre-existing media in claim 1, wherein the virtual portal is circle.

15. The system to provide multi-media augmented reality for pre-existing media in claim 1, wherein the perimeter of the virtual portal can be decorated in a manner complementary with the multi-media presentation.

16. A system to provide multi-media augmented reality for pre-existing media comprising
a user electronic appliance, comprised of a display, an image capture device, a processor, a memory element that is a first non-transitory computer readable medium, a movement sensing means, and a transmission means;
a server processing device connected to the user electronic appliance via the transmission means;
a database connected to the server processing device via circuitry;
a software application resident on the user electronic appliance memory element that, when running, activates the image capture device, displays the image received on the image capture device on the display, triggers the image capture device (“triggering the image”), capturing an image, and transmits the image via the transmission means to the server processing device;
a software method, embodied on a second non-transitory computer readable medium and accessible to the server processing device, capable of identifying if the captured image received from the user electronic appliance corresponds to an occurrence from a pre-existing media by determining if the captured image corresponds to a unique visual identifier associated with an occurrence from a pre-existing media, associating the unique visual identifier with a unique augmented reality record stored in the database, wherein the augmented reality record contains a multi-media presentation, and transmitting the multi-media presentation, via the transmission means, to the user electronic appliance;
wherein the multi-media presentation contains at least a graphic component; and
wherein, when triggered for activating the multi-media presentation (“triggering the augmented reality”), the user electronic device runs the multi-media presentation, renders the graphics on the display of the user electronic appliance, and superimposes the multi-media presentation, in real-time, over the then-current image being captured by the image capture device.

17. The system to provide multi-media augmented reality for pre-existing media in claim 16, wherein triggering the image is performed manually by the user.

18. The system to provide multi-media augmented reality for pre-existing media in claim 16, wherein triggering the image occurs automatically.

19. The system to provide multi-media augmented reality for pre-existing media in claim 18, wherein triggering the image automatically occurs at time intervals.

20. The system to provide multi-media augmented reality for pre-existing media in claim 19, wherein the time intervals are based off of a clock counter.

21. The system to provide multi-media augmented reality for pre-existing media in claim 18, wherein triggering the image automatically occurs based off of movement of the user electronic appliance that is sensed by the movement sensing means.

22. The system to provide multi-media augmented reality for pre-existing media in claim 16, wherein triggering the image is continuous.

23. The system to provide multi-media augmented reality for pre-existing media in claim 16, wherein triggering the augmented reality occurs manually.

24. The system to provide multi-media augmented reality for pre-existing media in claim 16, wherein triggering the augmented reality occurs automatically.

25. The system to provide multi-media augmented reality for pre-existing media in claim 24, wherein triggering the augmented reality occurs when a scalable frame is at least partially within the view of the image capture device of the user electronic appliance,
wherein the scalable frame is defined by at least two markers placed on a flat surface;
wherein the two markers allow the software application resident on the user electronic device to define a bounded two-dimensional geometric shape, with a defined perimeter and interior, called a virtual portal; and
wherein the graphic component of the augmented reality multi-media presentation is displayed on the display of the user electronic device, superimposed on the interior of the virtual portal.
